(19) United States
(12) Patent Application Publication
(10) Pub. No.: US 2003/0233462 A1
(43) Pub. Date: Dec. 18, 2003

(54) System and method for providing a digital rights scheme for browser downloads

(76) Inventor: Herman Chien, Redmond, WA (US)

Correspondence Address: PERKINS COIE LLP/AWS, P.O. BOX 1247, SEATTLE, WA, 98111-1247, US

(21) Appl. No.: 10/160,695

(22) Filed: May 30, 2002

(51) Int. Cl. G06F 15/16

(52) U.S. Cl. 709/229; 713/162; 713/160

(57) ABSTRACT

Disclosed embodiments include a system and method for protecting intellectual property rights, such as copyright rights, in an electronic file or other information to be transferred to a user on a device. In one embodiment, the system receives a request for a displayable file, such as a web page, from a user. The system then creates a web page for display to the user, where the web page includes one or more links to one or more electronic files. The system may then determine a level of protection for at least one of the electronic files and embed an indication of the level of copyright protection in at least one of the links to the electronic files. The system may comprise transmitting a file to the user after a user selects one of the links. Many other alternatives and alternative embodiments are also disclosed.

### BACKGROUND

Embodiments of the invention relate generally to devices and methods for providing a simple digital rights scheme for browser downloads, such as for files transmitted to a wireless device or a computer terminal.

Electronic media has revolutionized the traditional notion of how novels, magazines, or newspaper articles are conveyed to the public. Additionally, graphics, sounds, and other multimedia items, and the electronic distribution of these items, present new and different challenges when compared to traditional media. Now, more than ever, information surrounds us in a multitude of formats and in seemingly limitless supply. With all of these items, the desire for quick and easy distribution must be balanced with the need to protect the intellectual property, particularly copyright, of each.

The Internet, for example, has been found to be a phenomenal source of quick information. Indeed, the Internet's ability to convey information and facilitate communication throughout the world is arguably unparalleled. For these reasons, however, the Internet exacerbates the tension between the diametrically opposed goals of security and maintenance of property rights and the ease and versatility inherent in the Internet. Users often navigate the Internet with a browser, such at Netscape Navigator, Internet Explorer, a WAP-enabled browser, etc. Browsers are capable of downloading files to a user's machine (e.g., personal computer, wireless device, set-top box, etc.) using a variety of protocols, such as file transfer protocol (ftp), hypertext transfer protocol (http), etc.

Secure electronic media exists in many formats. To protect the interest of the author or copyright owner, works are often disseminated in such a fashion that prevents unauthorized copying. One method of preventing pirating of copyrighted works is to maintain the file on a server that can only be accessed by authorized users. While the content is protected, the versatility of the electronic media is lost. User must often possess lengthy and complex passwords and must maintain an Internet connection in order to access the media.

Another method of securing the content is tying the content to an individual display device or computer. Once downloaded from a secure site, a document contained in a file may be unlocked via a key. The key is often a long series of letters and numbers unique to each file. Once the downloaded file confirms that the key is correct, the file is locked into that machine through a hidden system file and hardware identification. If the file was transferred to another machine, the system file would be missing and even if the password were reentered, the hardware identification procedure would prevent the file from opening. While this version of security pleases many content providers, it is a nuisance to those desiring and using the content.

Cellular mobile telephony, or wireless telephony, provides additional problems for protecting and distributing content satisfactorily because of their hardware limitations, relatively narrow bandwidth, and on/off nature. Wireless telephony provides voice data links between users of mobile devices and fixed devices on a network. It gives users using a wireless phone or other wireless device mobility without regard to how they are actually connected to the network. This is done by providing access points or base station units that can hand off the connections of mobile devices without interruption of the service. 2G (second-generation) digital mobile phone service such as the Global System for Mobile Communications (GSM), EIA/TIA-136 Time Division Multiple Access (TDMA), TIA-IS-95 Code Division Multiple Access (CDMA), and the AMPS (analog mobile phone service) are examples of such telephone networks.

Wireless users often desire to download a wide variety of files to their wireless devices, such as ringtones, screensavers, applications, and other files. NTT DoCoMo of Tokyo, Japan (“DoCoMo”) provides a copyright scheme for files downloaded to wireless phones. In DoCoMo's scheme copyright information is bound very tightly inside the downloaded object itself. For example, in downloadable MIDI music and GIF image files, DoCoMo specifies that all of their handsets must examine a comment field within the respective MIDI or GIF file header. If a reserved keyword is seen, the handset must honor copyright restrictions by saving the downloaded object in a manner that prevents it from being forwarded, copied, or otherwise transmitted to any destination outside of the handset. However, this scheme only works with file types that have intrinsic comment fields and requires a customized browser or hardware to take advantage of the protection scheme.

Another digital rights protection scheme involves encapsulating the object to be protected inside of a wrapper (possibly including encryption) that triggers the desired handling and requires that the object be verified for the presence or absence of a tamper-resistant security mark. This method requires the presence of a trusted security layer on the receiving device that honors the declared copyright restrictions. This method also provides additional difficulties with compatibility and use by both current and legacy equipment.

Current digital rights schemes are plagued by inconvenience, incompatibilities, high cost, and both a failure to adequately protect intellectual property rights as well as provide lightweight protection for less critical content. Users and content providers alike continue to seek a balance between protection of intellectual property rights and the desire of the user to utilize the versatility of the different forms of electronic media.

### BRIEF DESCRIPTION OF THE DRAWINGS

FIG. 1 is a block diagram that illustrates components of a digital rights management system and user computers and wireless devices in one embodiment.

FIG. 2 is a flowchart depicting the embedding of copyright protection in a link to an electronic file in a first embodiment.

FIG. 3 is a flowchart depicting the receipt of an indication of copyright protection embedded in a link to an electronic file in the embodiment of FIG. 2.

FIG. 4 is a flowchart depicting the embedding of copyright protection in a link to an electronic file in a first alternative embodiment.

FIG. 5 is a flowchart depicting the embedding of copyright protection in a link to an electronic file in a second alternative embodiment.

FIG. 6 is a flowchart depicting the receipt of an indication of copyright protection embedded in a link to an electronic file in the embodiment of FIG. 5.

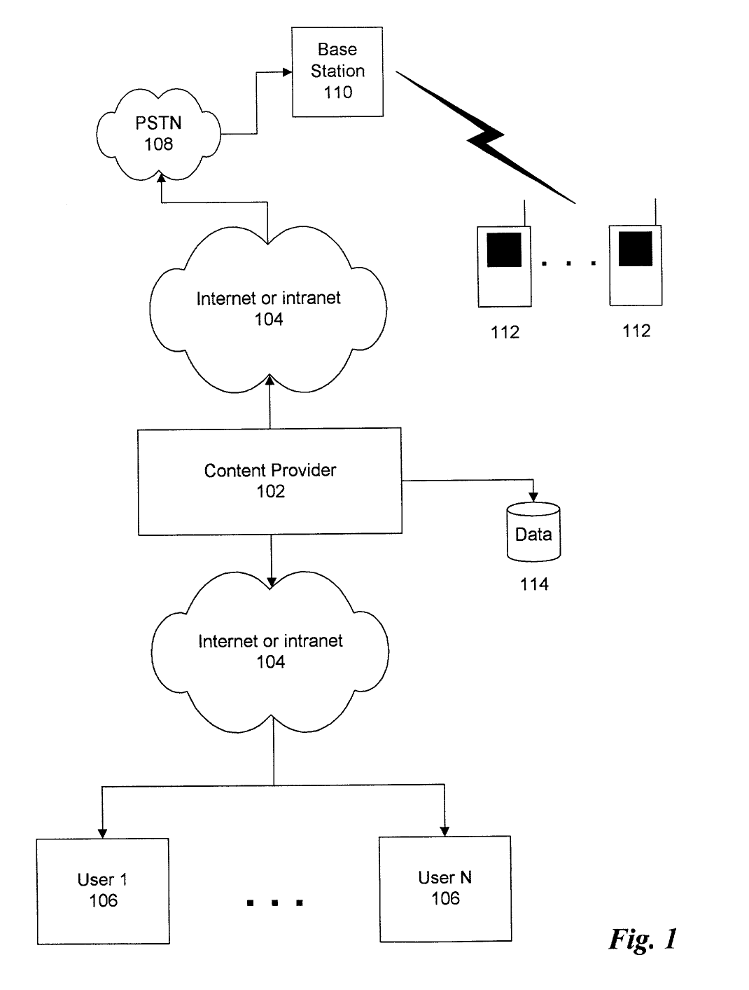

In the drawings, the same reference numbers identify identical or substantially similar elements or acts. To easily identify the discussion of any particular element or act, the most significant digit or digits in a reference number refer to the Figure number in which that element is first introduced, e.g., element 102 is first introduced and discussed with respect to FIG. 1.

Note that the headings provided herein are for convenience and do not necessarily affect the scope or interpretation of the invention.

### DETAILED DESCRIPTION

A system and method for conveying content protection interests and protecting intellectual property rights, such as copyright rights, in an electronic file or other information to be transferred to a user on a device is provided. In one embodiment, the system receives a request for a displayable file, such as a web page, from a user. The system then creates a web page for display to the user, where the web page includes one or more links to one or more electronic files. The system may then determine a level of protection for at least one of the electronic files and embed an indication of the level of copyright protection in at least one of the links to the electronic files. The system may comprise transmitting a file to the user after a user selects one of the links. In one alternative embodiment, the system may determine whether the user's device will honor the embedded limitation of the level of copyright protection.

In another alternative embodiment, the system may receive information relating to the user and analyze the information. In this embodiment, the system may determine the level of copyright protection based at least partially on the results of the analysis of the user information. In yet another alternative embodiment, the user device may be a wireless device, such as a wireless phone. In another embodiment, the user device may be a personal computer in communication with the Internet.

The system and method for embedding an indication of copyright protection in a link to an electronic file provides numerous benefits over other systems. For example, a content provider can easily embed such an indication in a link with relatively simple software and without having to customize the indication based on the user's device, eliminating undesirable complication and expense. Another benefit to the system is the ability to work with earlier devices that do not honor an embedded indication, if desired, increasing the amount of devices that are compatible. The described method also allows a content provider to individually identify each file and its copyright protection using existing browser syntax, providing a versatile and lightweight solution. Other benefits are described in more detail below.

The following description provides specific details for a thorough understanding of, and an enabling description of, embodiments of the invention. However, one skilled in the art will understand that the invention may be practiced without these details. In other instances, well known structures and functions have not been shown or described in detail to avoid unnecessarily obscuring the description of the embodiments of the invention.

FIG. 1 is a block diagram that illustrates components of a digital rights management system and user devices in one embodiment. The digital rights management server 102 and one or more user computers 106 are interconnected via a computer network 104, such as the Internet or an intranet. The digital rights management server 102 may be owned or maintained by a content provider or other entity that provides any sort of content, information, objects, or files to users. The computers may include a central processing unit, memory, input devices (e.g., keyboard and pointing device), output devices (e.g., display devices), and storage devices (e.g., a hard drive, a CD-ROM, a floppy disk drive, etc.). The memory and storage devices are computer-readable media that may contain instructions for implementing the digital rights management system. In addition, the data structures and message structures may be stored or transmitted via a data transmission medium, such as a signal on a communications link. Various communications channels may be used, such as a local area network, wide area network, or a point-to-point dial-up connection. One skilled in the art will appreciate that the digital rights management system can be implemented in other environments such as a client/server environment in which the digital rights management software executes on a client computer and accesses a database on a server computer that stores the content, customer data, etc.

The digital rights management server 102 may include a web engine that receives requests, such as HTTP requests, from user computers and determines an appropriate response, such as HTTP responses. The digital rights management server 102 may be in communication with or include a database 114, which may be used to store content, files, user information, intellectual property information, etc.

The digital rights management server 102 is also connected to one or more wireless devices 112, such as wireless phones owned by a user. The wireless device 112 communicates with a base station 110 via an antenna. The base station 110 may be in communication with a publicly switched telephone network (PSTN) 108 directly, via a mobile switching center (MSC), or via other facilities or methods. The PSTN 108, in turn, may be in communication with the digital rights management server 102 via a computer network 104, such as the Internet or an intranet. The antenna of the wireless device 112 allows wireless communications with a base station 101, access point, or other components of a wireless or cellular network.

Some embodiments of the present invention are intended for use with any suitable wireless device, such as a wireless phone or wireless web access device. By way of example, some embodiments will be described with reference to a wireless phone 112. The wireless phone 112 typically has a display screen and integral user input controls that are suitably buttons such as membrane switches. The wireless phone 112 also typically has an earpiece, such as a speaker, and voice input device, such as a microphone, for playing sounds to the user and receiving sounds from the user, respectively. One skilled in the art would recognize that other wireless devices are within the scope of the invention, such as a wireless web access telephone, wireless computer access device, Internet-enabled PDA, automobile-based web access device, laptop or palmtop computer, mobile or vehicle-based location-determining device (e.g., Global Positioning System-based device) or other portable or mobile communication devices. The wireless phone 112 may be any phone manufactured by, or substantially compatible with any phone manufactured by, companies such as Nokia, Ericsson, Motorola, etc. PDA's may be manufactured by, or substantially compatible with any phone manufactured by, companies such as Palm, Handspring, etc., or a PDA using the Windows CE, Palm, or other operating systems.

Wireless phones 112 often have a microbrowser, a browser customized for use on a wireless device, to browse web pages over an Internet connection. Wireless phones 112 may use Wireless Access Protocol (WAP) or other wireless protocols and markup languages such as Wireless Markup Language (WML), XHTML Mobile Profile, or Compact HTML to access the Internet. One skilled in the art will recognize that many alternative browsers, protocols, and markup languages may be used and would be within the scope of the invention.

Unless described otherwise below, the construction and operation of the various blocks shown in FIG. 1 and the other Figures are of conventional design. As a result, such blocks need not be described in further detail beyond that provided herein, because they will be understood by those skilled in the relevant art. Such further detail is omitted for brevity and so as not to obscure the detailed description of the invention. Any modifications necessary to the blocks in FIG. 1 (or other Figures and embodiments) can be readily made by one skilled in the relevant art based on the detailed description provided herein.

As described previously, users often navigate the Internet or other networks with a browser located on their computer or wireless device. Browsers are capable of downloading files to a user's machine and displaying graphics and multimedia files, playing sounds, providing links to pages or files located at other Internet sites, etc. The browser displays information on a computer or wireless device by interpreting Hypertext Markup Language (HTML), which is used to build and design pages (web pages) on the World Wide Web (“Web”). The coding in the HTML files tells a browser how to display the text, graphics, and multimedia files on the web page, and also tells the browser how to display any links to files or other web sites. The browser uses the references contained in the HTML links to find the appropriate files on the server and then to display, play, or download them, as appropriate. Accordingly, the browser will perform an action that is based on the nature of the link; for example, if the HTML code specifies web page graphics the graphic file will be found on the server and displayed, if the HTML code specifies a link to another web page the browser will retrieve the Uniform Resource Locator (URL) specified in the HTML file, if the HTML code specifies a file to be downloaded the browser will download the file to the user's device, etc. Wireless Markup Language (WML) codes and tags operate in a similar fashion to that of HTML, but WML is optimized for the hardware limitations and limited bandwidth of wireless devices. Another markup language is the eXtensible Markup Language (XML), which is based on HTML and is also intended to facilitate interaction with wireless devices. One skilled in the art will recognize that many markup languages are satisfactory and within the scope of the invention, such as HTML, XML, WML, XHTML, XHTML Basic, XHTML MP, etc.

HTML tags are typically surrounded by a less-than and a greater-than symbol, such as <link>. Tags may appear in pairs, with a starting and an ending tag surrounding relevant text. A wide variety of tags are available, as is described in more detail at the home page for the World Wide Web consortium, located at http://www.w3.org/MarkUp (Feb. 14, 2002), which is herein incorporated by reference, among other sources. One HTML tag that links documents together is called the anchor tag or the link tag. The anchor tag is made up of an opening tag (<A>) and an ending tag (</A>) surrounding other text. The text between the anchors may include one or more modifiers. One common modifier is HREF, which can be used to provide a link to another web page or file (depending on the file extension). For example, an HTML tag could be;

<A HREF=“http://www.site.com/directory/file.html”>The File<A>

In this example, the words “The File” would appear on the displayed screen for the user, and if a user selected the displayed link a connection would be created to the described URL “http://www.site.com/directory/file.html.” The browser treats the received file in accordance with the MIME type sent by the server with the file. In another example, an anonymous ftp service allows any person to download a file by clicking a link without having to log on to a server. To accomplish this, an HTML tag using ftp instead of http is used, such as:

<A HREF=“ftp://www.site.com/directory/file.gif”>The File<A>

This may also be accomplished using http instead of ftp, such as if a user right-clicks on the link and selects the download or save-as options. The right-click is a Microsoft Windows convention, and any user interface methodology may be used, such as the click-hold paradigm of the Macintosh, 3-button mice, etc. The anchor tag may contain other attributes besides the HREF attribute. In its current configuration, the anchor tag may include a wide variety of attributes, such as a name attribute (which names the anchor so that it may be the destination of another link), a type attribute (which specifies the type of content available at the link target address, a title attribute (which defines a title that is informational only), etc. A detailed summary of the anchor tag and its attributes is included at http://www.w3.org/TR/htm14/struct/links.html (Feb. 14, 2002), which is incorporated herein by reference.

The method of embedding a copyright indication in a link to a file provides numerous benefits over the prior art. For example, when compared to the scheme provided by DoCoMo in which copyright indications must be expressed within available space inside the object (if such commentary is allowed by the object's governing encoding standard), the disclosed method leverages the free format fields within the markup language itself which are associated one-to-one with the specific object being downloaded instead of embedding the information in the object itself. It is relatively easy to engineer an enhanced browser that can examine the otherwise-ignored comments, and the disclosed method supports all possible downloadable files, even those without intrinsic comment fields. The disclosed method is therefore highly compatible, as old content is unlikely to inadvertently include the specific text strings that trigger copyright handling on newer devices. Also, new content that contains the specific text strings would not trigger any special behavior on the old handsets because the old browsers would treat the fields as unrecognized tags that, by convention, are gracefully ignored. Accordingly, many content providers would desire to detect the browser type (such as in the HTTP header exchange) and refuse to download a file or other object to a browser that does not honor the copyright scheme. This is a simple scheme with corresponding security tradeoffs. All copyright protection schemes involve a tradeoff of convenience, cost, etc. versus the level of security. In this scheme, the object to be downloaded must be “in the open” and as mentioned earlier, could be retrieved using any handwritten web page if the URL of the object were known. Thus, the security of this scheme depends on whether the URL can be kept secret and whether it is worth the trouble for content thieves to waste their time disseminating the secret if it's discovered. For low value, short lifetime content, this tradeoff may be more appropriate.

The digital rights management scheme described herein may be considered either a simple digital rights management scheme or even a forward blocking scheme, as this scheme does not necessarily include encryption or other security features. Instead, this scheme simply may be used to prevent the forwarding or downloading of the content in the first place. The digital rights management scheme should therefore be considered to include any download solution, such as simple mechanism that allows a content provider to indicate whether content is copyright protected or not. Moreover, links are anything that causes a browser to retrieve a data entity, not simply a clickable anchor link, and accordingly may involve either active user clicks or be done automatically by the browser.

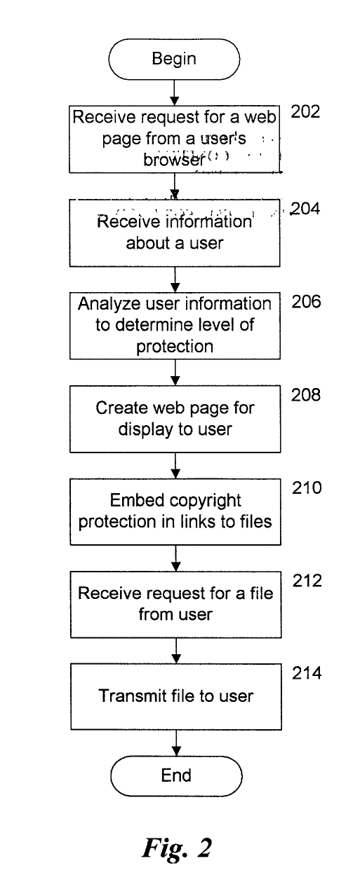

FIG. 2 is a flowchart depicting the embedding of copyright protection in a link to an electronic file in a first embodiment. The embedding of FIG. 2 may be used by a content provider to provide copyright protection to an electronic file, web site, link, or other object. In block 202, the digital rights management system (which may be run, for example, on digital rights management server 102) receives a request for a web page from a user. In one embodiment, the request for a web page would originate from a user on a device (such as an Internet-enabled personal computer or wireless phone) that is equipped with a browser or other software that enables navigation of the Internet.

In block 204, the system optionally receives information about a user. For example, the system could receive information about the user's device, the copyright protections available on the user's device, identifying information about the user, account information, payment information, how many times a user has accessed a file, a group to which the user belongs, the user's purchased level of copyright protection, the user's geographic location, the time of the user's request, etc. The function continues in block 206, where the system optionally analyzes the user information to determine the level of protection. In one example, the user's account information could be received (such as from a cookie) and the function could analyze information located on a remote server or database in order to determine if the user is authorized to download the file. Blocks 204 and 206 are optional and only need be used if the content provider desires to customize the function based on user information instead of having a link that treats all users similarly.

In block 208, the function creates a web page for display to the user and transmits that web page (or its component information) to the user. The web page may contain one or more links to files that may be downloaded, as well as links to other items, such as other web pages, etc. In block 210, the function embeds an indication of copyright protection in one more of the links. In one embodiment, the indication of copyright protection is included within the anchor tag by including the indication within the ‘name’ element. The name element is traditionally used as a way to name a link that another link might jump to and is not commonly used. Accordingly, by including an indication in the name element, it is unlikely that there will be any side effects for older browsers, as most browsers simply ignore any extraneous language in the name element. The indication could be any text used to indicate the level of copyright protection. For example, if the text “NAME=NOCOPY” were used this could indicate to a user (and/or their browser) that a file could be downloaded that could not be copied (such as a file that could only be used on the device to which it is originally downloaded). An example link would be:

<A HREF=“ftp://www.site.com/directory/file.gif”NAME=“NOCOPY”>Click to get a picture that can't be copied<A>

This link would download the file “file.gif” located in the directory “directory” at www.site.com to the user, and the link would appear to the user as “Click to get a picture that can't be copied.” If the user's device and browser allowed, an indication of NAME=“NOCOPY” would also be seen and interpreted so that the user's browser would know the appropriate level and could take the associated steps to protect the copyright. The use of the name field allows a content provider to easily convey copyright restrictions on the object to the user's browser. In one embodiment, a standard set of indications would be developed, but any text could be used to provide an indication of the copyright protection. One skilled in the art will recognize that many types of copyright indications could be used and be within the scope of the invention, such as limitations on time, number of uses, limitations on copying and saving, limitations on the number of users, limitations on software that the file works with, etc. Each of these indications, which may be called “keywords,” and their functions may be agreed upon by content providers and device manufacturers.

In an alternative embodiment, other elements within the anchor tag besides the name element could be used, such as the elements id, target, rel, rev, charset, type, etc. These elements could be populated with arbitrary titles or alternative descriptive text. The content provider could simply use one of the flexible fields to incorporate a predefined keyword (e.g., ID=NOCOPY, etc.) to convey the copyright restrictions to the user's browser. Use of these other elements, each with their own intended uses, does increase the chance that older browsers will not be able to handle the use of these elements for purposes for which they were not originally intended.

In another alternative embodiment, a new name/value pair could be introduced into the anchor tag syntax to convey copyright information (e.g., a new element would be created). For example, a new pair such as COPYRIGHT=“keyword” could be defined, where the element is ‘copyright’ and keyword could take on any number of predefined values representing various policies. As browsers typically ignore unrecognized language elements, compatibility problems would be minimized.

The function continues in block 212 when the function receives a request for a file or other object from a user. This occurs when a user selects a link to a file or object, such as by clicking on the link with a mouse. In block 214, the file is transmitted to the user and the function terminates.

In another alternative embodiment, the content provider may choose to deliver a web page or allow a download to a device and guaranteeing that the content protection policies are delivered simultaneously. This prevents users from taking advantage of one possible security hole in the scheme, which results when a user captures the web page with the object's URL, removes the flag and saves the new web page, and acquires the content by visiting the modified page which now lacks the flag. Legacy devices will tend to fall into two categories, those which freely allow forwarding and those which block all forwarding. The behavior of the content after it arrives at such a legacy device will depend on these native behaviors which are known to content provider by virtue of the known make and model of the phone determined during HTTP capability header exchanges. The MIME based method is more secure and also easy to implement. Specifically, implementation simply requires that the HTTP server add the appropriate MIME type based on the desired state of protection for the delivered object. Legacy device compatibility handled in a reasonable way as well, namely that legacy devices will tend to reject the unrecognized MIME types as unacceptable objects and reject them, thereby eliminating any risk of forwarding on legacy devices which might employ a wide open philosophy.

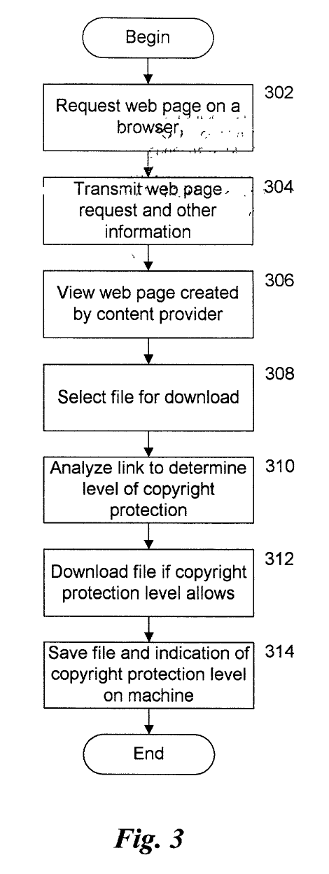

FIG. 3 is a flowchart depicting the receipt of an indication of copyright protection embedded in a link to an electronic file in the embodiment of FIG. 2. The embodiment depicted in FIG. 3 is a modification of the embodiment of FIG. 2 described from the perspective of the user. In general, alternatives and alternative embodiments described herein are substantially similar to previously described embodiments, and common elements and functions are identified by the same reference numbers. Only significant differences in construction or operation are described in detail. In block 302 of FIG. 3, the user requests a web page on a browser. This may occur when a browser is opened (the start-up page), when a user selects a web site by tying in its name in the browser, by clicking on a link on a web page, etc. In block 304, the function transmits the web page request and any other information to the digital rights management server 102. As described above, the other information could include user information, contents of a ‘cookie,’ etc. In block 306, the function receives and displays the web page created by the content provider. One skilled in the art will recognize that the functions of blocks 302, 304, and 306 are well known in the art and other alternative methods are available to accomplish them.

The function continues in block 308, where the user selects a file for download. This may be accomplished by selecting a link on the displayed web page with a mouse button. In one embodiment, a variety of links to the files may be displayed, each one with a different level of copyright protection which reflects different objects with varying levels of quality and price. In block 310, the browser analyzes the link to determine the level of copyright protection. In one embodiment, the indication of copyright protection could be associated with the name or other current elements, and in another embodiment, the indication could be associated with a custom copyright element or name/value pair located within the anchor tag. Typically, a keyword will have a predefined meaning with respect to the level of copyright protection.

In block 312, the user's browser downloads the file or other object if the copyright protection allows a download. In one embodiment, one possible copyright level of protection could be no download, which could be used, for example, when the user does not have a valid account with the content provider. In another embodiment, downloading is always permitted. The function continues in block 314, where the browser saves the downloaded file or object and optionally saves an indication of the copyright protection level on the user's device, after which the function completes. For example, an indication of the copyright protection level could be stored as a ‘wrapper’ on the downloaded file, could be stored in a database on the user's device, etc. The digital rights management system only works if the user's device and browser honor the indication of copyright protection, and prevent the user from accomplishing any unauthorized actions. Almost all protection schemes have some vulnerabilities, and the digital rights management system described herein is no exception. The vast majority of users, however, are unlikely to modify their hardware or software to bypass the copyright protections of the digital rights management system.

In another embodiment, the object is simply stored in such a way that ensures that the copyright indications are honored in any subsequent handling of the object by the device. A no-copy flag in a file system might be one implementation (as described above), but a database that aligns with all of the objects stored on the device or other alternative is also possible.

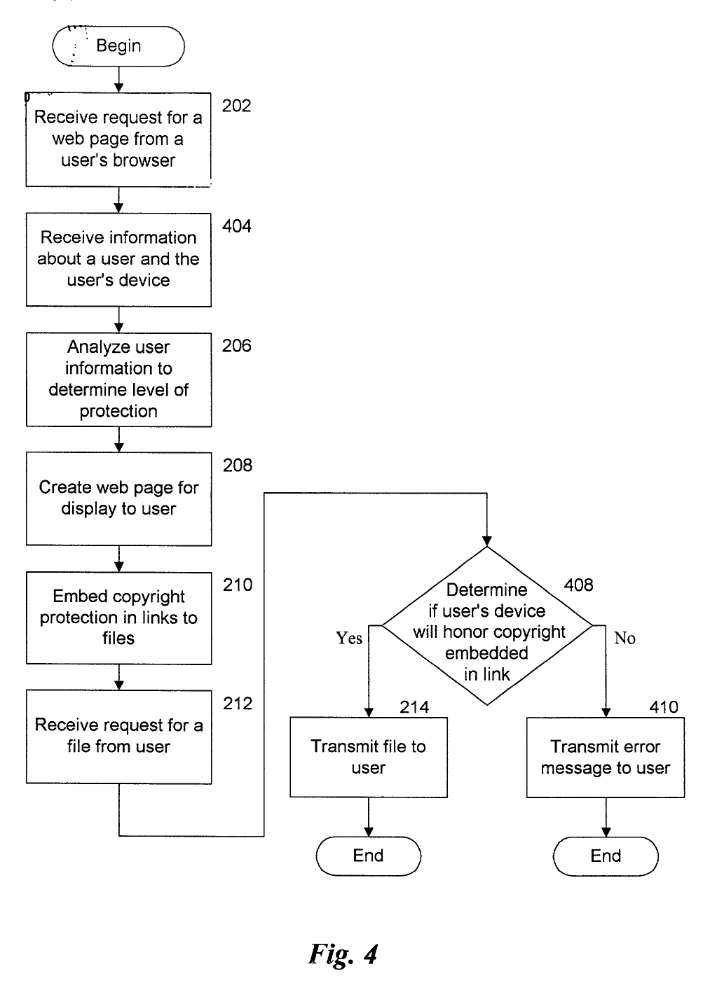

FIG. 4 is a flowchart depicting the embedding of copyright protection in a link to an electronic file in a first alternative embodiment. The embodiment depicted in FIG. 4 is a modification of the embodiment of FIG. 2. In block 404, the function receives information about a user and the user's device. This information will allow the function to customize the copyright protection, and thus the links, for each user. For example, one user (e.g., a premium user) could have unlimited rights in a downloaded object, while another user (e.g., a user sampling the system) may only have rights for one week. In block 408, the function analyzes the user's device (based on the information received in block 404) in order to determine if the user's device will honor the copyright protection embedded in the link. If so, the function continues to block 214 where the object is transmitted to the user. If not, the function refuses to transmit the object and instead may transmit an error message or other indication that the object will not be transferred.

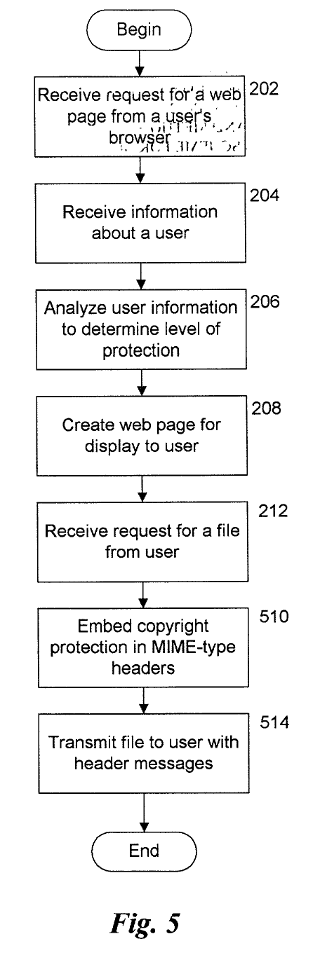

FIG. 5 is a flowchart depicting the embedding of copyright protection in a link to an electronic file in a second alternative embodiment. The embodiment depicted in FIG. 5 is a modification of the embodiment of FIG. 2. As described below, the embodiment of FIG. 5 takes advantage of an indication of copyright protection embedded in Multipurpose Internet Mail Extension (MIME) types associated with a downloaded file.

When an HTML browser retrieves a file, the browser must know what type of data it has received in order to know how to handle it. During the download process, the HTTP protocol exchanges headers that describe the capabilities of the client and server (e.g., user with a browser) as well as defining the type of file to be exchanged. While HTTP servers explicitly tell the browser the type of data being sent, a browser using FTP to access a remote file must guess the data type based on the file name extension. Web servers uses MIME types to define the type of a particular piece of information being sent from a Web server to a browser. The browser will then determine from the MIME type how the data should be treated. HTTP servers send MIME contents-types header messages ahead of every file they deliver to a browser. The header explicitly tells the browser what type of data is being sent.

One HTTP header field is the Content-Type field that usually takes the form Content-Type=“keyword” where “keyword” is usually a well-known string such as “image/jpeg,” “audio/midi,” etc. The MIME-type syntax is extendable (such as by vendors) if certain conventions are followed, namely the use of the “vnd” keyword. For example, syntax such as “application/vnd.wap.wm” will isolate custom MIME-types to a space where no compatibility issues are likely to occur. This permits a custom MIME-type to be defined for copyright purposes. The server would serve a MIME-type in the header that is associated with the downloaded object, where the MIME-type would express the desired copyright policy. The device would be obligated to honor the policy expressed in the MIME-type. In one example,

Content-Type=image/vnd.content-provider.midi.nocopy

This example indicates a content-provider-defined MIME-type that imposes no-copy restrictions.

Returning to FIG. 5, after receiving a request for a file from a user in block 212, the function continues in block 510 where the digital rights management system embeds copyright protection in MIME-type headers. In one example, the system may take advantage of the extendable syntax available by use of the “vnd” keyword, as described above. The function continues in block 514, where the file or other object is transmitted to a user on a device along with the MIME header messages, after which the function terminates. One skilled in the art will recognize that many other alternative methods are available for utilizing MIME-type headers and are within the scope of the invention.

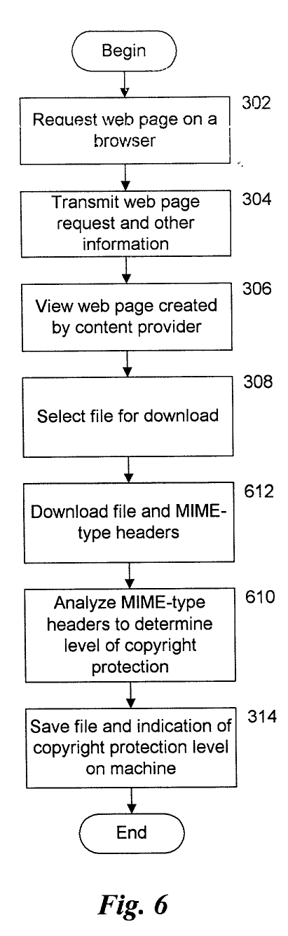

FIG. 6 is a flowchart depicting the receipt of an indication of copyright protection embedded in a link to an electronic file in the embodiment of FIG. 5. The embodiment depicted in FIG. 6 is a modification of the embodiment of FIG. 5 described from the perspective of the user. In block 612, the user downloads both the file and the MIME-type headers associated with the file. The function continues in block 610, the browser analyzes the MIME-type headers to determine the level of copyright protection. In one embodiment, the indication of copyright protection could be associated with extendable syntax related to the “vnd” keyword, and in another embodiment, the indication could be associated with a customized extension of the MIME-type header or other modification of MIME-type headers

One skilled in the art will recognize that any combination of the above embodiments, as well as other embodiments, are possible and within the scope of the invention. For example, embedding of an indication of copyright protection in MIME-type headers may be utilized with the embodiment describing analyzing information about a user to assist in determining the level of copyright protection.

The system and method for embedding an indication of copyright protection in a link to an electronic file provides a number of benefits. For example, a content provider may individually identify each file and its copyright protection using existing browser syntax, providing a versatile and lightweight solution that minimizes compatibility problems. Another benefit to the system is the ability to work with earlier devices that do not honor an embedded indication, if desired, increasing the amount of devices that are compatible and preventing legacy systems from bypassing the copyright protection. These are just some of the benefits provided by the system and method described herein.

In the PC world, any image rendered on a web page using the <img> tag can typically be saved as a file to disk. Those images can be used in a variety of ways that the content author may not desire. The link methods (the reuse of existing attributes or the creation of a new attribute) as well as the MIME type methods both can also be applied to the <img src=mypicture.gif> tag that displays an image on a page. The purpose of extending the protection methods to the <img> tag is that a variety of protections can be applied to a rendered image. The content author, however, may wish to regulate other uses beyond temporary visibility (e.g. no saving, allow save but no forwarding, etc.). With suitably encoded attributes in the <img> tag or MIME types, these policies can be communicated to the phone or other user device. One skilled in the art will recognize that other embodiments are possible, such as schemes utilizing the <a> tag, the <object> tag, etc.

Those skilled in the relevant art will appreciate that the invention can be practiced with various telecommunications or computer system configurations, including Internet appliances, hand-held devices, wearable computers, palm-top computers, cellular or mobile phones, multi-processor systems, microprocessor-based or programmable consumer electronics, set-top boxes, network PCs, mini-computers, mainframe computers, and the like. Aspects of the invention can be embodied in a special purpose computer or data processor that is specifically programmed, configured, or constructed to perform one or more of the computer-executable instructions explained in detail herein. Indeed, the term “computer,” as used generally herein, refers to any of the above devices, as well as to any data processor. Data structures and transmission of data particular to aspects of the invention are also encompassed within the scope of the invention. In general, while hardware platforms such as stationary and mobile devices are described herein, aspects of the invention are equally applicable to nodes on the network having corresponding resource locators to identify such nodes.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “above,” “below,” and words of similar import, when used in this application, shall refer to this application as a whole and not to any particular portions of this application. Use of the term “or,” as used in this application with respect to a list of two or more items, shall be interpreted to cover any, all, or any combination of items in the list.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. The teachings of the invention provided herein may be applied to other systems, not necessarily the system described herein. The various embodiments described herein can be combined to provide further embodiments. These and other changes can be made to the invention in light of the detailed description.

These and other changes can be made to the invention in light of the above detailed description. In general, the terms used in the following claims should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

I/We claim:

1. An apparatus comprising:
a housing;
a wireless transceiver, at least partially retained by the housing, for communicating with a computer network by way of a publicly switched telephone network;
an output device;
an input device;
a memory module; and
a processor at least partially retained by the housing and coupled to the wireless transceiver, the memory module and the input and output devices, the processor being adapted to receive an Internet link to a file to be downloaded from the computer network, wherein the link includes one of several indications of copyright protection for the file, wherein each indication of copyright protection corresponds to a differing level of copying to be permitted, and wherein further the processor is adapted to handle the file in accordance with the indication of copyright protection.

2. The apparatus of claim 1 wherein the link is a link to a file on a remote server, wherein the link is an HTML link, and wherein further the indication of copyright protection is located within the anchor tag of the HTML link.

3. A method of providing copyright protection to at least one electronic file to be transferred to a user on a device over a network, comprising:
via the network, receiving a request for a displayable file from a user;
determining a level of copyright protection for at least one of the electronic files;
creating the displayable file for display to the user, the displayable file including one or more links to one or more electronic files; and
embedding an indication of the level of copyright protection in at least one of the links to the one or more electronic files.

4. The method of claim 3 further comprising after a user selects at least one of the links, transmitting the associated electronic file to the user.

5. The method of claim 3 further comprising determining whether the user's device will honor the embedded indication of the level of copyright protection.

6. The method of claim 3 further comprising:
determining whether the user's device will honor the embedded indication of the level of copyright protection; and
refusing to transmit the electronic file if the user's device will not honor the embedded indication of the level of copyright protection.

7. The method of claim 3 further comprising:
receiving information relating to the user;
analyzing the user information; and
wherein determining the level of copyright protection is based at least partially on the results of the analysis of the user information.

8. The method of claim 3 wherein the user's device is a wireless device.

9. The method of claim 3 wherein the user's device is a wireless phone.

10. The method of claim 3 wherein the user's device is a personal computer.

11. The method of claim 3 wherein the displayable file is a web page created using HTML code.

12. The method of claim 3 wherein the displayable file is a web page created using XML code.

13. The method of claim 3 wherein the user's device is a wireless phone, and wherein further the electronic file is a screensaver.

14. The method of claim 3 wherein the user's device is a wireless phone, and wherein further the electronic file is a ringtone.

15. The method of claim 3 wherein the user's device is a wireless phone, and wherein further the electronic file is an audio file.

16. The method of claim 3 wherein the user's device is a wireless phone, and wherein further the electronic file is an image.

17. The method of claim 3 wherein the user's device is a wireless phone, and wherein further the electronic file is an application.

18. The method of claim 3 wherein the indication of copyright protection indicates that the electronic file should not be copied or forwarded.

19. The method of claim 3 wherein the indication of copyright protection indicates that the electronic file should only be accessed a predefined number of times.

20. The method of claim 3 wherein the indication of copyright protection indicates that the electronic file should only be accessed for a predefined period of time.

21. The method of claim 3 wherein the indication of copyright protection is embedded in the anchor tag of at least one of the links.

22. The method of claim 3 wherein the indication of copyright protection is embedded in the name element of the anchor tag of at least one of the links.

23. The method of claim 3 wherein the indication of copyright protection is embedded in an element of the anchor tag dedicated to providing an indication of copyright protect.

24. A method, for use by a user using a device, of downloading electronic files from a computer coupled to a network in accordance with a copyright protection scheme, comprising:
at the device, receiving a displayable file, the displayable file including one or more links to one or more electronic files;
at the device, receiving a selection of one of the links to the one or more electronic files from the user;
at the device, transmitting the selection to the computer over the network;
at the device, downloading the one or more electronic files associated with the link selected by the user;
at the device, determining the level of copyright protection for at least one of the electronic files, wherein the level of copyright protection is determined at least partially based on an indication of the level of copyright protection embedded in at least one of the links; and
storing at the device an indication of the level of copyright protection for at least one of the downloaded files.

25. The method of claim 24 further comprising storing at least one downloaded electronic file.

26. The method of claim 24 wherein the device is a wireless phone.

27. The method of claim 24 wherein the displayable file is a web page.

28. A computer-readable medium whose contents cause control logic in a wireless device to perform a method to provide copyright protection to at least one electronic file to be transferred to a user on a device, comprising:
receiving a request for a displayable file;
determining a level of copyright protection for at least one of the electronic files;
creating a displayable file, the displayable file including one or more links to one or more electronic files;
embedding an indication of the level of copyright protection in at least one of the links to the one or more electronic files; and
after a user selects at least one of the links, transmitting the associated electronic file to the user.

29. The computer-readable medium of claim 28 wherein the displayable file is a web page.

30. The computer-readable medium of claim 28 wherein the computer-readable medium is a computer-readable disk.

31. The computer-readable medium of claim 28 wherein the computer-readable medium is a data transmission medium transmitting a generated data signal containing the contents.

32. The computer-readable medium of claim 28 wherein the computer-readable medium is a memory of a computer system.

33. An apparatus for providing copyright protection to at least one electronic file to be transferred to a user on a device:
means for receiving a request for a displayable file;
means for determining a level of copyright protection for at least one of the electronic files;
means for creating a displayable file, the displayable file including one or more links to one or more electronic files; and
means for embedding an indication of the level of copyright protection in at least one of the links to the one or more electronic files.

34. A computer-readable medium containing a data structure for use by a digital rights management system, the data structure comprising:
an HTML link to at least one file to be downloaded by a user, the HTML link including at least one anchor tag; and
an indication of a level of copyright protection, the indication being embedded in the HTML link.

35. The computer-readable medium of claim 34 wherein the indication of a level of copyright protection is located within a name element embedded in the anchor tag.

36. The computer-readable medium of claim 34 wherein the computer-readable medium is a data transmission medium transmitting a generated data signal containing the contents..

37. A method of providing copyright protection to at least one electronic file to be transferred to a user on a device, comprising:
receiving a request for a web page from a user;
determining a level of copyright protection for at least one of the electronic files;
creating a web page for display to the user, the web page including one or more links to one or more electronic files;
embedding an indication of the level of copyright protection in at a MIME-type header associated with at least one of the one or more electronic files; and
transmitting the at least one electronic files with any associated MIME-type headers.

38. The method of claim 37 wherein the indication of the level of copyright protection is located in the Content-Type header field, and wherein further the indication utilizes MIME-type extendable syntax.

39. A method of providing copyright protection to at least one electronic file to be transferred to a user on a device over a network, comprising:
determining a level of copyright protection for at least one of the electronic files;
creating the displayable file for display to the user, the displayable file including one or more links to one or more electronic files;
embedding an indication of the level of copyright protection in at least one of the links to the one or more electronic files; and
storing the at least one link to the one or more electronic files.
